(19) United States
(12) Patent Application Publication
(10) Pub. No.: US 2020/0096200 A1
(43) Pub. Date: Mar. 26, 2020

(54) STEPPER MOTOR DRIVEN MODULATING GAS VALVE AND SYSTEM

(71) Applicants: Tony Leeseberg, Elgin, IL (US); James E. Pearson, Downers Grove, IL (US); Curtis Phillips, Bloomingdale, IL (US)

(72) Inventors: Tony Leeseberg, Elgin, IL (US); James E. Pearson, Downers Grove, IL (US); Curtis Phillips, Bloomingdale, IL (US)

(73) Assignee: Robertshaw Controls Company, Itasca, IL (US)

(21) Appl. No.: 16/577,954

(22) Filed: Sep. 20, 2019

Related U.S. Application Data
(60) Provisional application No. 62/734,083, filed on Sep. 20, 2018.

(51) Int. Cl. F24C 3/12; F16K 31/04; F23N 1/00; H02K 7/116

(52) U.S. Cl. CPC F24C 3/126; F16K 31/042; F23N 1/005; F23N 2041/08; F23N 2035/24; F23N 2035/14; H02K 7/116

(57) ABSTRACT

A stepper motor driven modulating gas valve and system are provided. Such a system includes an electronic controller, a touch user interface, and a stepper motor. The system also includes a variable flow gas valve having a rotatable valving member for controlling a variable flow of gas therethrough, the valving member having an input shaft, and a gear train operatively coupling the output shaft of the stepper motor to the input shaft of the valving member of the variable flow gas valve. A burner is coupled to the variable flow gas valve. The electronic controller receives a user input for flame selection via the touch user interface and energizes the stepper motor to position the variable flow gas valve valving member to a predetermined angular position through the gear train to provide a flow of gas to the burner that will provide the user's desire flame intensity.

### CROSS-REFERENCE TO RELATED PATENT APPLICATIONS

This patent application claims the benefit of U.S. Provisional Patent Application No. 62/734,083, filed Sep. 20, 2018, the entire teachings and disclosure of which are incorporated herein by reference thereto.

### FIELD OF THE INVENTION

This invention generally relates to gas control valves for consumer appliances, and more specifically to electrically actuated gas control valves for consumer appliances.

### BACKGROUND OF THE INVENTION

Typical cooktop burner flame control in a gas fed appliance relies on the user to turn a knob mounted on the appliance and observe the flame height or intensity, or markings on the user knob. Such knobs are mechanically linked to a gas valve to open or close its valving member more or less. Modern pilot-less appliances often use direct spark ignition to ignite the gas flowing out of the burner, and the user knobs typically include an indication of the angular position for such ignition, in addition to flame settings of high, medium, and low or simmer.

Unfortunately, such required user mechanical control requires intervention throughout the cooking process. That is, user intervention is required for turning on the gas to the burner with the knob, positioning the knob such that ignition takes place, adjusting the knob to the proper flame intensity after ignition for the start of the cooking process, adjusting the knob during the cooking cycle to increase or decrease the flame intensity, e.g. to go from vigorous boil to simmer, etc.

With the advent of electronic controls and capacitive and other touch-sensitive surfaces, some appliance manufacturers have moved away the mechanical user knob and valve to provide user input and control during a cooking cycle. In such appliances, the electronic controller senses the touch interface and positions the variable flow gas valve to the user desired position electronically. The controller also allows programmed control of heating cycles. One such system is described in U.S. Pat. No. 7,527,072 entitled, “Gas Cook-Top With Glass (Capacitive) Touch Controls And Automatic Burner Re-Ignition,” assigned to the assignee of the present application, the teachings and disclosure of which are hereby incorporated in their entireties by reference thereto.

While the consumer demand for and features provided by such electronic controls are desirable, to provide electronic control of gas burners, electronically controllable gas valves become necessary. One such valve particularly well suited for such electronic control, besides those disclosed in the '072 patent, above, is disclosed in U.S. Patent Application Publication No. 2010/0140520 A1 entitled, “Variable Flow Gas Valve and Method for Controlling Same,” assigned to the assignee of the present application, the teachings and disclosure of which are hereby incorporated in their entireties by reference thereto.

Unfortunately, such electronically controllable gas valves tend to be more expensive than the simple mechanical gas control valves that are controlled by mechanical knobs and mechanical interfaces. There exists a need, therefore, for a more cost effective electronically controllable gas valve for use in a consumer appliance such that the benefits of electronic control can be realized in lower price-point appliances.

Embodiments of the present invention provide such a gas control valve and system utilizing same. These and other advantages of the invention, as well as additional inventive features, will be apparent from the description of the invention provided herein.

### BRIEF SUMMARY OF THE INVENTION

In view of the above, embodiments of the present invention provide a new and improved stepper motor driven modulating gas valve and system that addresses one or more of the above identified problems existing in the art. More particularly, embodiments of the present invention provide a new and improved stepper-motor-driven modulating gas valve and system that utilizes conventional and inexpensive mechanical interface gas control valves traditionally used on appliance cooktops with user knob interfaces driven by an electronic controller and providing an electronic interface, such as a user touch interface for flame selection. Embodiments of the present invention also provide electronic programming control of the flame intensity.

In a specific embodiment, the modulating gas valve utilizes an aluminum tapered plug within a tapered aluminum housing. However, it is understood that materials other than aluminum may be suitable for this application. Preferably, the valve plug rotates to provide variable flows of gas therethrough. A gas flow turndown ratio of 10:1 is provided in one embodiment (1,000 to 10,000 or 1,500 to 15,000 BTU/hr. for example), although other turndown ratios are envisioned.

In one embodiment, a saddle mount provides the interface to a round gas manifold. In another embodiment, a bolt through mount is utilized to provide the interface for appliances having a square manifold. In one embodiment, the inlet utilizes a ⅜″ NPT connection, and the outlet utilizes a mini-valve standard tubing connection.

The valve plug may be rotated by a stepper motor controlled by an electronic control module or electronic controller. In one embodiment, the stepper motor is a 12 Vdc stepper motor. Preferably, a gear train interfaces the stepper motor output shaft to the valve plug shaft to allow for enhanced granularity of gas flow control to provide near continuous variation of gas flow. This allows, in one embodiment, for 1,180 steps of motor movement to equate to approximately 266.3° of valve angular position displacement, 800 steps to approximately 180.7° displacement, 400 steps to approximately 89.6° displacement, etc. One of ordinary skill in the art will recognize that the angular position displacements and number of steps recited above are exemplary and each may be expresses as a range of values rather than a specific value. Furthermore, other gearing ratios can increase or decrease such relationship as desired, and allows for use of smaller or larger stepper motors.

In one embodiment, the gas supply system for the appliance provides up to 100,000 BTU/hr. natural gas (NG) flow capacity. In such an embodiment, each modulated valve has a capacity of approximately 14,500 BTU/hr. per CSA certification test parameters. In certain embodiments, the system includes a master shutoff valve, such as a normally-closed solenoid valve at 100,000 BTU/hr. In such embodiments, the master valve shuts off gas supply to all modulating valves in the event of a power outage or other failure. As such, the master valve must be open to allow gas to flow to the modulating valves. In a typical installation, the master shutoff valve is operated from a 12 Vdc supply.

In one embodiment, the system includes a power/control board, or controller, for the cook-top. In certain embodiments, the controller operates from a standard 120 Vac supply, although other source voltages, i.e., some variation of Vac, is envisioned. In a particular embodiment, the controller controls the master shutoff valve discussed above. The controller is also configured to control the flow rate and valve position for the variable gas flow valves of the present invention. Preferably, the controller utilizes re-ignition controls. In one embodiment, the ignition zone valve rotation may be from 40°-270°.

In one embodiment, a sliding touch variable flow control sensor is provided so as to relay a user's desired flame setting to the controller, although other embodiments utilize other electronic or mechanical selection input to the controller. The controller in one embodiment provides a two-step ignition/valve opening sequence, i.e., touch one button and sequence another button to start operation. For safety, one embodiment delays operation to assure the stepper motor is at home/closed position before starting the opening rotation at around 60° and opening the solenoid valve for ignition.

In one aspect, embodiments of the invention provide a stepper-motor-driven modulating gas flow valve that includes a stepper motor having an output shaft that is controlled steps by an electronic controller; and a valving member for controlling a flow of gas through the gas flow valve. The valving member is coupled to an input shaft such that rotation of the input shaft operates the valving member to open or close the gas flow valve. A gear train operatively couples the output shaft of the stepper motor to the input shaft of the valving member.

In a particular embodiment, the electronic controller is configured to rotate the output shaft in discrete steps, and in other embodiments, the electronic controller is coupled to a user interface. In certain embodiments, the output shaft of the stepper motor, the input shaft of the valving member, and the gear train are integrated into a single housing.

In a further embodiment, the valving member is a rotatable tapered plug disposed in a tapered housing. The valving member may be configured such that the gas flow valve has a turndown ratio of 10 to 1. The stepper motor and the master shutoff valve may be configured to operate using a 12-volt DC supply voltage, and the electronic controller may be configured to operate using a 120-volt AC supply voltage. In some embodiments, the ignition zone valve rotation ranges from 40° to 270°.

In one aspect, embodiments of the invention provide a gas flow control system having an electronic controller, a user interface coupled to the electronic controller, and a modulating gas flow valve with a stepper motor having an output shaft that is controlled by the electronic controller in response to a user selection via the user interface. The gas flow valve includes a valving member for controlling a flow of gas through the gas flow valve. The valving member is coupled to an input shaft such that rotation of the input shaft operates the valving member to open or close the gas flow valve. A gear train operatively couples the output shaft of the stepper motor to the input shaft of the valving member.

The gas flow control system further includes a burner coupled to the variable flow gas valve. The electronic controller receives a user input for flame selection via the user interface, and controls the stepper motor to position the valving member to a predetermined position through the gear train to provide a flow of gas to the burner.

In some embodiments, the burner is one of a cooktop burner, a hearth burner, a hot water burner, a pool heater burner, a grill burner, and an oven burner. The electronic controller may programmed to control at least one of a flame height of the burner, and a time duration of burner operation, and may be further programmed to automatically vary the height and duration of burner operation based on user input via the user interface. Further, the electronic controller may be configured to rotate the output shaft in discrete steps, and may be configured to control the stepper motor to position the valving member to a predetermined angular position.

In certain embodiments, the valving member is a rotatable tapered plug disposed in a tapered housing. The gas flow control system may also include a master shutoff valve couples between a gas supply input and the modulating gas flow valve, and the master shutoff valve may be a normally-closed solenoid valve. Further, in some embodiments, the user interface comprises a sliding touch variable flow control sensor. In other embodiments, the stepper motor and the master shutoff valve are configured to operate using a 12-volt DC supply voltage, and the electronic controller is configured to operate using a 120-volt AC supply voltage.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic illustration of an embodiment of a cooktop burner control system utilizing modulating gas valves in accordance with the teachings of the present invention;

FIG. 2 is an embodiment of a touch control panel a cooktop burner control system utilizing modulating gas valves in accordance with the teachings of the present invention;

FIG. 3 is an illustration of an embodiment of a motor drive housing for modulating gas valves in accordance with the teachings of the present invention;

FIG. 4 is a front view illustration of an embodiment of a modulating gas valve, burner, and touch control panel in accordance with the teachings of the present invention;

FIG. 5 is an isometric view illustration of the embodiment of the modulating gas valve, burner, and touch control panel shown in FIG. 4;

FIG. 6 is a simplified side view illustration of the embodiment of the modulating gas valve, burner, and touch control panel shown in FIG. 4.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

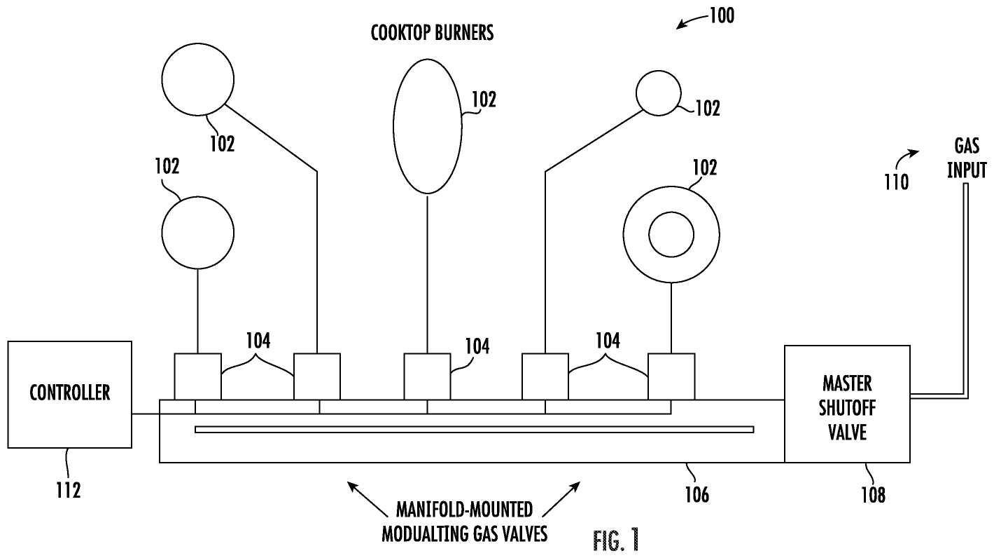

Turing now to the drawings, there is illustrated in FIG. 1 an exemplary operating environment of a consumer appliance cooktop 100 that is particularly well suited for application of embodiments of the present invention. However, such an operating environment and system should be taken by way of example and not by way of limitation as other applications of the teachings of the present invention will become apparent to those skilled in the art from the teachings herein.

Such other applications of embodiments of the present invention, besides the illustrated cooking burner application, include but are not limited to, a hearth flame control (providing 40,000 to 50,000 BTU through a Robertshaw high-capacity mini-valve with a pressure drop of approximately 2 psi), an instantaneous hot water heater (which currently uses combination valves that adjust the pressure on regulator and multiple coils to modulate the BTU output) providing approximately 100,000 to 200,000 BTUs, pool heaters, outdoor grill applications, residential and commercial oven modulation (currently use BJ valves for constant heat), etc.

As show in FIG. 1, a five-burner cooktop appliance 100 is illustrated, with each burner 102 being controlled by an individual modulating gas flow valve 104 of the present invention. Each of these modulating gas flow valves 104 is mounted to a gas manifold 106, the flow of gas into which is controlled by a master shutoff valve 108 connected to the gas input 110 to the appliance. In one embodiment, a saddle mount (not shown) provides the interface to a round gas manifold 106. In another embodiment a bolt-through mount (not shown) is utilized to provide the interface for appliances having a square manifold 106. In one embodiment, the inlet utilizes a ⅜″ National Pipe Thread (NPT) connection, and the outlet utilizes a mini-valve standard tubing connection.

In one embodiment, the gas supply system for the appliance 100 provides up to 100,000 BTU/hr. natural gas (NG) flow capacity. In such an embodiment, each modulated valve has a capacity of approximately 14,500 BTU/hr. per CSA certification test parameters. In certain embodiments, the appliance 100 includes the master shutoff valve 108 in the form of a normally-closed solenoid valve. In such embodiments, the master shutoff valve 108 shuts off gas supply to all modulating gas flow valves 104 in the event of a power outage or other failure. As such, the master shutoff valve 108 must be open to allow gas to flow to the modulating gas flow valves 104. In a typical installation, the master shutoff valve 108 provides 12 Vdc operation.

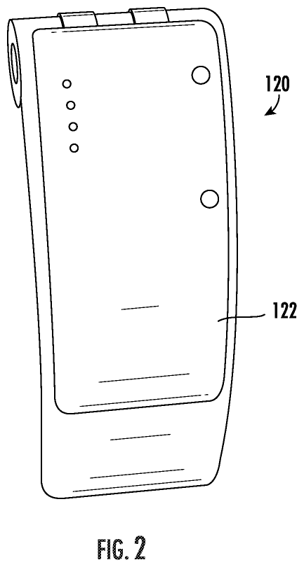

FIG. 2 illustrates one embodiment of a user touch interface 120 that provides the user input to the appliance controller 112 to control the gas flow, and therefore the flame intensity for each burner. In one embodiment, a single sliding touch variable flow control sensor 122 is provided so as to relay a user's desired flame setting for each burner 102 to the controller 112. In other embodiments, each burner 102 includes its own sliding touch variable flow control sensor 122. While not illustrated in FIG. 2, other burner control icons, such as buttons, knobs, etc., are provided in alternate embodiments that relate to preset flame heights or gaseous fuel flow to the burner 102, e.g., simmer, low, medium, high, or to particular temperature settings, e.g., keep warm, gentle, delicate, etc. The controller 112 drives the modulating gas flow valves 104 to the corresponding presetting of gas flow when one of these icons are selected.

The controller 112 in one embodiment provides a two-step ignition/valve opening sequence, i.e., touch one button for burning selection (or ignition selection) and sequence another button to start operation, i.e., either slide along the interface to increase from low to high (or vice versa) or simply touch anywhere along the scale. For safety, one embodiment delays operation to assure the stepper motor 130 is at the home/closed position before starting the opening rotation at around 60° and opening the solenoid valve for ignition. Programmed operation of the flame height, time duration, variable height and duration for different cooking phases, etc. are also available via the electronic controller 112.

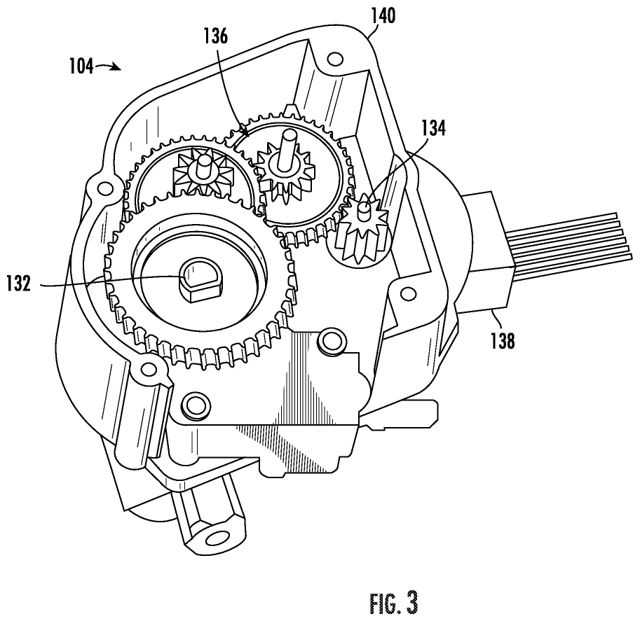

FIG. 3 illustrates in partial deconstructed form one embodiment of the modulating gas flow valve 104 of the present invention. As may be seen, the output shaft of the stepper motor 130 is coupled through a gear train 136 to the valving member of the modulating gas flow valve 104 itself, which interface was provided by the user knob. In the embodiment of FIG. 3 shown, the valving member is not visible being located behind a housing 140 which houses the gear train 136. In certain embodiments, the valving member is rotatable.

In one embodiment, the modulating gas flow valve 104 utilizes an aluminum tapered plug as the valving member. In a more particular embodiment, the tapered plug is disposed within a tapered aluminum housing. In certain embodiments, the valve plug rotates to provide variable flows of gas through the modulating gas flow valve 104. A gas flow turndown ratio of 10:1 is provided in one embodiment (1,000 to 10,000 or 1,500 to 15,000 BTU/hr. for example), although other turndown ratios are envisioned.

The valve plug may be rotated by a stepper motor 130 controlled by an electronic control module, or electronic controller (112 in FIG. 1) through the illustrated gear train 136. In one embodiment, the stepper motor 130 is a 12 Vdc stepper motor 130. As shown in FIG. 3, the gear train 136 interfaces the stepper motor output shaft 132 to the valve plug shaft 134 to allow for enhanced granularity of gas flow control to provide near continuous variation of gas flow. As can be seen, the stepper motor output shaft 132, the valve plug shaft 134, and the gear train 136 may integrated into the single housing 140.

The configuration described above allows, in one embodiment, for 1,180 steps of motor movement to equate to approximately 266.3° of valve angular position displacement, 800 steps to approximately 180.7° displacement, 400 steps to approximately 89.6° displacement, etc. One of ordinary skill in the art will recognize that the angular position displacements and number of steps recited above are exemplary and each may be expresses as a range of values rather than a specific value. Other gearing ratios can increase or decrease this relationship as desired, and allows for the use of smaller or larger stepper motors 130.

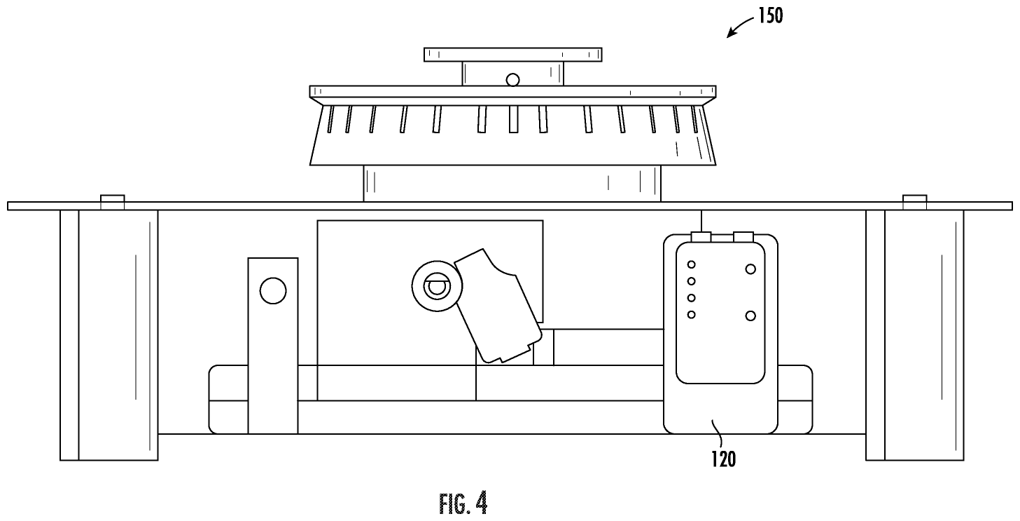

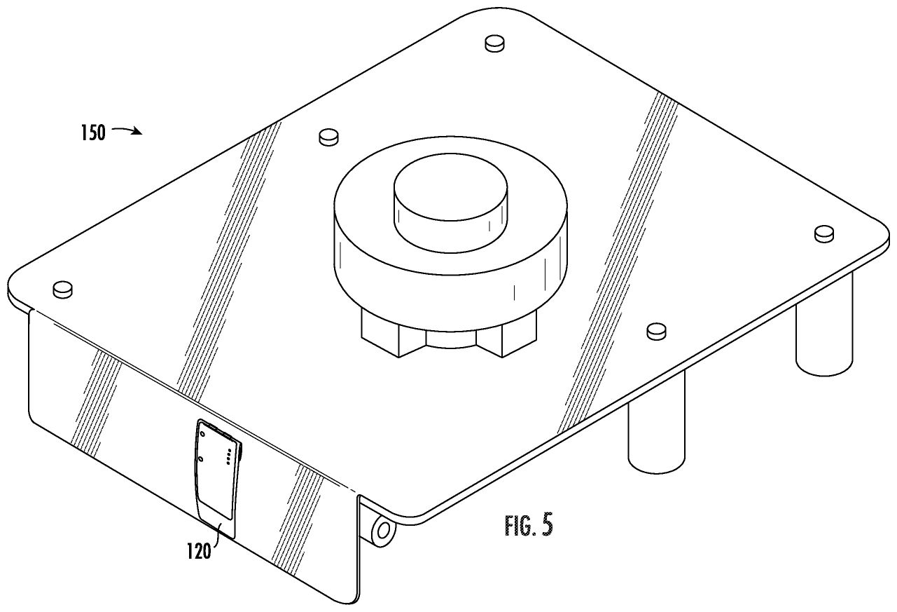

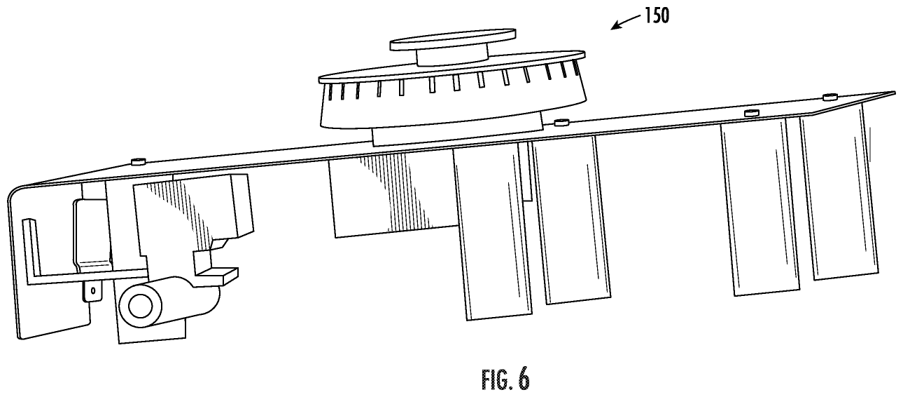

FIGS. 4-6 provide additional perspective views of a mock-up showing an exemplary embodiment of a single burner 150, constructed in accordance with an embodiment of the invention. The single burner 150 including a touch interface 120 on a front of the panel. The touch interface 120 may include the sliding touch variable flow control sensor 122 shown in FIG. 2. It is noted that the illustrations have been simplified by removing the gas piping from the modulating gas flow valve 104 to the burner 102.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A stepper-motor-driven modulating gas flow valve, comprising:
a stepper motor having an output shaft that is controlled steps by an electronic controller;
a valving member for controlling a flow of gas through the gas flow valve, the valving member coupled to an input shaft such that rotation of the input shaft operates the valving member to open or close the gas flow valve; and
a gear train operatively coupling the output shaft of the stepper motor to the input shaft of the valving member.

2. The modulating gas flow valve of claim 1, wherein the electronic controller is configured to rotate the output shaft in discrete steps.

3. The modulating gas flow valve of claim 1, wherein the electronic controller is coupled to a user interface.

4. The modulating gas flow valve of claim 1, wherein the output shaft of the stepper motor, the input shaft of the valving member, and the gear train are integrated into a single housing.

5. The modulating gas flow valve of claim 1, wherein the valving member is a rotatable tapered plug disposed in a tapered housing.

6. The modulating gas flow valve of claim 1, wherein the valving member is configured such that the gas flow valve has a turndown ratio of 10 to 1.

7. The modulating gas flow valve of claim 1, wherein the stepper motor and the master shutoff valve are configured to operate using a 12-volt DC supply voltage.

8. The modulating gas flow valve of claim 1, wherein the ignition zone valve rotation ranges from 40° to 270°.

9. The modulating gas flow valve of claim 1, wherein the electronic controller is configured to operate using a 120-volt AC supply voltage.

10. A gas flow control system, comprising:
an electronic controller;
a user interface coupled to the electronic controller;
a modulating gas flow valve comprising:
a stepper motor having an output shaft that is controlled by the electronic controller in response to a user selection via the user interface;
a valving member for controlling a flow of gas through the gas flow valve, the valving member coupled to an input shaft such that rotation of the input shaft operates the valving member to open or close the gas flow valve; and
a gear train operatively coupling the output shaft of the stepper motor to the input shaft of the valving member;
a burner coupled to the variable flow gas valve; and
wherein the electronic controller receives a user input for flame selection via the user interface, and controls the stepper motor to position the valving member to a predetermined position through the gear train to provide a flow of gas to the burner.

11. The gas flow control system of claim 10, wherein the burner is one of a cooktop burner, a hearth burner, a hot water burner, a pool heater burner, a grill burner, and an oven burner.

12. The gas flow control system of claim 10, wherein the electronic controller is programmed to control at least one of a flame height of the burner, and a time duration of burner operation.

13. The gas flow control system of claim 12, wherein the electronic controller is programmed to automatically vary the height and duration of burner operation based on user input via the user interface.

14. The gas flow control system of claim 10, wherein the electronic controller is configured to rotate the output shaft in discrete steps.

15. The gas flow control system of claim 10, wherein the valving member is a rotatable tapered plug disposed in a tapered housing.

16. The gas flow control system of claim 15, wherein the electronic controller controls the stepper motor to position the valving member to a predetermined angular position.

17. The gas flow control system of claim 10, further comprising a master shutoff valve couples between a gas supply input and the modulating gas flow valve.

18. The gas flow control system of claim 17, wherein the master shutoff valve is a normally-closed solenoid valve.

19. The gas flow control system of claim 10, wherein the user interface comprises a sliding touch variable flow control sensor.

20. The gas flow control system of claim 10, wherein the stepper motor and the master shutoff valve are configured to operate using a 12-volt DC supply voltage, and the electronic controller is configured to operate using a 120-volt AC supply voltage.
